(19) United States
(12) Patent Application Publication
(10) Pub. No.: US 2026/0314612 A1
(43) Pub. Date: Oct. 15, 2026

(54) PRE-EVISCERATION DEVICE

(71) Applicant: Marel Poultry B.V., AV Boxmeer (NL)

(72) Inventors: Cas Lucas Pieter Scholten, AV Boxmeer (NL); Bas Drabbels, AV Boxmeer (NL); Engelbertus Johannes Jacobus Teurlinx, AV Boxmeer (NL)

(73) Assignee: Marel Poultry B.V., AV Boxmeer (NL)

(21) Appl. No.: 19/113,677

(22) PCT Filed: Sep. 19, 2023
(86) PCT No.: PCT/EP2023/075787

§ 371 Date: Mar. 20, 2025

(30) Foreign Application Priority Data
Sep. 27, 2022 (EP) 22198092.3

(51) Int. Cl. A22C 21/00; A22C 21/06

(52) U.S. Cl. CPC A22C 21/0092; A22C 21/06

(57) ABSTRACT

Pre-evisceration device for preparing the evisceration of a poultry carcass, wherein the poultry carcass is beheaded and comprises: at least a part of the neck and the neck skin, a viscera pack comprising at least the esophagus and the crop, wherein the pre-evisceration device comprises a neck deskinner configured to remove at least a part of the neck skin from the poultry carcass prior to evisceration of the viscera pack.

The present invention relates to the field of processing slaughtered poultry carcasses, in particular in the stages of the preparation of evisceration or evisceration itself.

After the poultry has been slaughtered, the viscera pack is removed from the carcass. This is usually done via a vent opening while the carcass is suspended upside down, e.g. by using an evisceration tool. The viscera pack is usually not completely loosened from the rest of the carcass prior to evisceration, meaning that during the evisceration some connections between the viscera pack and the carcass must be broken by the force used to pull the viscera pack out of the carcass.

Some types of poultry, e.g. chickens, have a crop. The crop is an expanded, muscular pouch near the gullet or throat. It is a part of the digestive tract, essentially an enlarged part of the esophagus. The crop is used to temporarily store food. Generally, poultry that is about to be slaughtered is kept void of food for some time, as a result of which the crop of slaughtered poultry is supposed to be empty. The crop is generally positioned in the décolletage between the breast fillets, adjacent the tip of the breastbone, and hence also adjacent the furcular. The crop itself is fragile and vulnerable, whereas both ends of the crop are firmly connected to the esophagus and trachea: one end adjacent the body cavity and opposed thereof at the neck side. In general, the evisceration tool contacts the crop connection at the end adjacent the body cavity.

A common problem during evisceration is that the crop may break due to the force used to pull the viscera pack out of the carcass. It is estimated that this may happen in up to 60% of chickens if no additional measures are taken. When the crop breaks, an additional cleaning step may be required to remove the contents of the crop that polluted the meat of the poultry, as well as additional step for removing parts of the viscera pack that remained in the poultry carcass, e.g. part of the crop and the esophagus. Such cleaning step is e.g. disclosed in EP1247453B1.

EP3426050B1, which is incorporated herein by reference, attempts to reduce contamination by remains and contents of the crop in the evisceration process. This is done by making a slit in the longitudinal direction of the neck, and thereafter entering the slit with a release tool for releasing at least part of the esophagus and trachea at the neck side of the crop.

An object of the invention is to overcome or at least partially mitigate the disadvantages of the prior art, or at least provide an alternative. A particular object of the invention is to reduce the number of crops that are broken during evisceration.

This object is achieved with a pre-evisceration device for preparing the evisceration of a poultry carcass, wherein the poultry carcass is optionally beheaded and comprises:
at least a part of the neck and the neck skin,
a viscera pack comprising at least the esophagus and the crop,
   wherein the pre-evisceration device comprises a neck deskinner configured to remove at least a part of the neck skin from the poultry carcass prior to evisceration of the viscera pack.

The invention thus relates to a pre-evisceration device, meaning that it is used prior to the evisceration. For example, the pre-evisceration device can be arranged in a processing line, with an evisceration device being arranged at a processing station downstream of the pre-evisceration device. It is also possible that the pre-evisceration device and the evisceration device are incorporated in a single processing station. The pre-evisceration device can e.g. be part of a carousel device comprising a plurality of pre-evisceration devices, or can be embodied as a linear arrangement inline in the processing line.

In the pre-evisceration device, a poultry carcass is prepared for evisceration. The poultry carcass can e.g. be a chicken carcass of a turkey carcass. It is noted that within this context, the carcass does not need to be a complete carcass, i.e. it can also be considered a carcass part. At least the head can be removed, as the poultry carcass is usually beheaded priorly, optionally in a processing station in the same processing line upstream of the pre-evisceration device. Note however that the invention also envisages that the neck skin can be removed prior to beheading the poultry carcass. Further carcass parts can optionally be removed priorly, but the poultry carcass comprises at least a part of the neck skin. Optionally, the poultry carcass comprises the legs and/or feet of the poultry, and the pre-evisceration device comprises an overhead conveyor system with a plurality of shackles configured to hold the poultry carcass suspended by the legs while moving through the pre-evisceration device.

The poultry carcass further comprises a viscera pack, comprising at least esophagus and the crop. The esophagus is e.g. still connected to the neck (and/or the neck tissue and/or the neck skin). Usually, the viscera pack will comprise further organs such as the heart, the lungs, the liver, the stomach, the intestines, and the trachea. The viscera pack will later be eviscerated from the poultry carcass, e.g. in an evisceration device. Usually the objective of the evisceration device is to remove viscera pack completely in one processing step.

The pre-evisceration device comprises a neck deskinner configured to remove at least a part of the neck skin from the poultry carcass. This is thus done prior to evisceration of the viscera pack, meaning that at least the esophagus and the crop remain in the poultry carcass. The neck skin is thus loosened from the esophagus and harvested. Optionally, substantially all of the neck skin is removed from the poultry carcass. The neck deskinner can function in various ways, some of which will be illustrated in more detail herein.

The invention thus entails that the neck skin is removed from the poultry carcass prior to the evisceration of the viscera pack. The inventors have found that without this measure, the crop may often be the weakest link in the viscera pack and therefore break during evisceration. However, the neck skin strengthens the connection of the esophagus. By removing the neck skin, the esophagus is not connected to the poultry carcass that strongly. This provides a predefined weakest connection, such that this connection is broken instead of the crop during evisceration.

In embodiments, the neck deskinner comprises: a skin grabber configured to grab the neck skin; and a skin slitter configured to make a slit in the neck skin. Optionally, the neck deskinner is configured to exert a pulling force on the neck skin after the slit has been made for removing the neck skin from the poultry carcass. Optionally, the skin grabber is configured to exert said pulling force on the neck skin. For example, the skin grabber may pull the neck skin in a direction away from the poultry carcass. Making a slit before pulling the neck skin has the advantage that the location where the neck skin tears off is better defined. It is noted that the neck deskinner exerting a puling force after the slit has been made does not exclude the neck deskinner from already exerting said pulling force before the slit has been made (in addition to after the slit being made), and optionally while the slit is being made.

The neck deskinner may e.g. comprise a driving mechanism for moving the skin grabber. The driving mechanism can e.g. comprise an actuator, e.g. controlled by a control unit. The driving mechanism can e.g. comprise a cam-follower mechanism, e.g. a follower wheel following a cam track, e.g. on a drum of a carousel. The skin grabber can e.g. comprise one or more roller. The skin grabber can e.g. comprise a pincher or a jaw (e.g. comprising two jaw elements). The skin slitter can e.g. comprise a stationary or a rotating blade.

The neck deskinner may e.g. be configured to generate the pulling force by a relative movement between the skin grabber and the poultry carcass. The relative movement can e.g. be achieved by moving the skin grabber relative to the poultry carcass. The relative movement can e.g. be achieved by moving the poultry carcass relative to the skin grabber. The relative movement can e.g. be achieved by moving the skin grabber and the poultry carcass in opposite direction. The relative movement can e.g. be in a horizontal direction, in a vertical direction, in an angular direction, or in a combination thereof. A shackle of a conveyor may e.g. be configured to move the poultry carcass relative to the skin grabber.

In some embodiments, the skin grabber may be configured to grab the skin before the slit has been made. The skin may then already be held tighter, which may make it easier to make a slit on a well-defined location.

In some embodiments, the skin grabber may be configured to grab the skin after the slit has been made. The presence of the slit may make it easier to grab the skin and immediately exert the pulling force.

In embodiments, the skin slitter is configured to make the slit in a direction substantially perpendicular to a longitudinal direction of the neck. For example, when the poultry carcass is hanging suspended from the legs, the slit may be in the horizontal direction. It has been found that providing the slit in this direction, allows to define better the location where the neck skin tears of from the neck than when the slit is made in longitudinal direction. Substantially perpendicular may entail that an angle between the longitudinal direction and the direction in which the slit extents may deviate slightly from 90 degrees, e.g. up to 5, 10, or 15 degrees more or less than 90 degrees.

Optionally, the neck deskinner is configured to exert the pulling force in a direction perpendicular to the slit, e.g. parallel to the longitudinal direction. For example, when the poultry carcass is hanging suspended from the legs, the pulling force may be downwards. This further ensures that the location where the neck skin tears of from the neck is well-defined.

Optionally, the skin slitter is configured to make the slit on the breast-side of the neck of the poultry. Optionally, the skin slitter is configured to make the slit at a breast-end of the neck. Optionally, the skin slitter is configured to make the slit on the back-side of the neck of the poultry. Optionally, the skin slitter is configured to make the slit at a back-end of the neck. The breast-end and the back-end of the neck are both the opposite of a head-end of the neck.

In embodiments, the skin grabber comprises a first jaw part and a second jaw part configured to close towards each other for grabbing the neck skin. Optionally the skin grabber is configured to move the first and second jaw part simultaneously for pulling the neck skin away from the neck. Optionally the pre-evisceration device is configured to move the poultry carcass away from the skin grabber for pulling the neck skin away from the neck. The neck skin can thus be grabbed between the jaw parts, and then be pulled away from the poultry carcass by moving the jaw parts and poultry carcass relative to each other. The neck deskinner can e.g. comprise a driving mechanism, e.g. having an actuator and/or a cam-follower mechanism, for moving the jaw parts. The driving mechanism may e.g. comprise a first pivot for the first jaw part and second pivot for the second jaw part, configured for causing the first and second jaw part to pivot between an open position for receiving the neck and a closed position for grabbing the neck skin. Optionally, the first jaw part and/or the second jaw part have a toothed profile, e.g. comprising a plurality of protrusions and recesses, e.g. wherein the protrusions of the first jaw part are configured to be arranged in the recesses of the second jaw part when the first and second jaw part are closed towards each other. This meshing in a closed position may improve the grabbing of the neck skin. The first and/or second jaw part may e.g. be embodied as skin grabbing blocks.

In embodiments, the skin grabber comprises a rotatable gripper roll and counter member, wherein the skin grabber is configured to grab the neck skin between the rotatable gripper roll and the counter member, and to pull the neck skin away from the neck by rotating the rotatable gripper roll. The counter member can e.g. be stationary, e.g. be a shoe. The counter member can e.g. be a second rotatable gripper roller. The rotatable gripper roller(s) can have a profile, e.g. rectilinear of helical. The neck deskinner can e.g. comprise a driving mechanism, e.g. one or more motors, for rotating the rotatable gripper roller(s).

In embodiments, the skin grabber comprises a first skin grabber block pivotable about a first pivot axis and a second skin grabbing block pivotable about a second pivot axis, wherein the first and second skin grabbing block are configured to be pivoted about the first and second pivot axis, respectively, between an open position for receiving the neck skin and a closed position for grabbing the neck skin. The movement from open to closed position may e.g. entail a pivoting of less than 90 degrees, e.g. less than 45 degrees.

Optionally, the first and second skin grabbing block both comprise a grooved profile with a plurality of grooves and recesses, wherein in the closed position the grooves of the first skin grabbing block are arranged in the recesses of the second skin grabbing block and vice versa, wherein optionally the grooves extend at an angle with both the horizontal and the vertical direction. The inventors have found that the grooved profiles help to pull the neck skin further between the first and second skin grabbing block when they are moved to the closed position.

Optionally, the first and second skin grabbing block both comprise neck-facing surface having a curvature, and configured to face and engage the neck when the first and second skin grabbing block are arranged in the closed position. The curvature may e.g. be adapted to the curvature of the neck. By providing this neck-facing surface with curvature, it can be avoided that the neck is pulled between the first and second skin grabbing block together with the neck skin.

In embodiments, the skin slitter comprises a stationary blade. The poultry carcass can e.g. be moved relative to the stationary blade, e.g. by a conveyor system.

In embodiments, the skin slitter comprises a rotating blade.

In embodiments, the skin slitter comprises a blade that is moved relative to the poultry carcass, optionally while the poultry carcass and blade are simultaneously moved in a transport direction. This can e.g. be an advantageous embodiment when the pre-evisceration device is part of a carousel machine.

In embodiments, the skin slitter comprises a first blade and a second blade that are configured to make a snipping movement for making the slit in the neck skin.

In embodiments, the pre-evisceration device further comprises a loosening unit configured loosen at least a part of the tissue surrounding the esophagus after the neck skin has been removed by the neck deskinner. This may be advantageous to further weaken the connection between the esophagus and the poultry carcass. Said connection can thus be made weaker than the crop, and thereby ensure that the breaking point during evisceration is the connection between the esophagus and the poultry carcass, rather than the crop. Furthermore, with the neck skin being removed, the loosening unit can easily reach the tissue to be loosened. The tissue can e.g. include membranes, muscles, blood vessels, tendons. The loosening unit can optionally comprise one or more loosening members that are configured to move. Optionally the loosening unit comprises a driving mechanism for moving the loosening member(s), which may e.g. comprise a motor, an actuator, and/or a cam-follower mechanism. Optionally, the poultry carcass is moved relative to the loosening member(s) for loosening the tissue.

In embodiments, the loosening unit is further configured to loosen at least a part of the tissue surrounding to the trachea after the neck skin has been removed by the skin grabber. The trachea is usually also removed during evisceration, and is also connected to the neck of the poultry carcass. By loosening the tissue, said connection is weakened. This connection is preferably weaker than the crop, to ensure the breaking point during evisceration is not the crop.

In embodiments, the loosening unit comprises at least one loosening member, optionally two loosening members, wherein the loosening member is configured to move in the longitudinal direction relative to the esophagus for loosening the tissue. For example, when the poultry carcass is suspended by the legs, the loosening member(s) may be configured to move in downwards direction, or the poultry carcass can be moved in upwards direction (e.g. because a conveyor is configured accordingly). For example, when the loosening member has two loosening members, each loosening member may engage tissue on opposite sides (e.g. left and right) of the esophagus and/or trachea. The loosening member(s) may e.g. be pin(s). Optionally, the loosening member(s) is(/are) not sharp, e.g. the loosening member(s) rounded, square, triangular, dull, or blunt. That is, the loosening member(s) are not blades or knifes.

In embodiments, the loosening unit comprises at least one loosening member configured to loosen the tissue, wherein the loosening member is configured to have the same relative movement relative to the poultry carcass as the skin grabber for exerting the pulling force. For example, the skin grabber and loosening member may be configured to move simultaneously. For example, the skin grabber and loosening member may be configured to be held stationary while the poultry carcass is being moved.

In embodiments, the loosening unit comprises a loosening member that is hook-shaped with a hook-bend, wherein the hook-bend is configured to be arranged around the esophagus, wherein the loosening member is configured to be moved in a direction perpendicular to the longitudinal direction of the esophagus for loosening the tissue.

In embodiments, the pre-evisceration device further comprises a neck positioner configured to arrange the neck of the poultry carcass in a predetermined position prior to the neck skin being removed. The neck positioner may e.g. be configured to move along with the poultry carcass through the pre-evisceration device.

The neck positioner may e.g. comprise a neck support for positing the neck region of the poultry carcass. The neck support may e.g. comprise two neck plates. The neck support may e.g. be configured to support the neck when the skin grabber grabs the neck skin and/or when the skin slitter makes the slit, and optionally be configured to stop supporting the neck before or during the pulling force being exerted onto the neck skin. Optionally, the neck support is configured to be moved between an open position for allowing the neck to be arranged in the neck positioner, and a closed position for supporting the neck. Optionally, the neck support can be pivoted about a pivot axis for movement between the open and closed position.

The neck positioner may e.g. comprise a shoulder support for positing the shoulder region of the poultry carcass. The shoulder support may e.g. comprise two shoulder support extension each for supporting a shoulder, and a recess between the shoulder support extensions for receiving the neck.

In embodiments, the pre-evisceration device further comprises a breast support configured to support the breast of the poultry carcass. Optionally, the breast support is configured to be moved between an open position for allowing the neck to be arranged in the neck positioner, and a closed position for supporting the breast. Optionally, the breast support can be pivoted about a pivot axis for movement between the open and closed position.

In embodiments, the pre-evisceration device further comprises a skin collector configured to receive the neck skin after being removed from the neck. The skin collector can e.g. be a hopper, a conveyor belt, or a collector bin.

Optionally, the pre-evisceration device further comprises a neck skin tracing system configured to enable identifying from which poultry carcass the neck skin has been removed. Optionally, the neck skin is traceable at least until the poultry carcass has been subjected to an inspection. Usually, such inspection is performed after the evisceration based on the eviscerated viscera pack. From the viscera pack, it may be visually notable if the poultry carcass is unfit for (human) consumption, e.g. due to sickness. In such case, the parts of the poultry carcass that have been harvested earlier are usually also not suitable for (human) consumption. As the neck skin tracing system allows to remove the neck skin in such case, it allows at the same time that the neck skins of healthy poultry carcasses can be used for (human) consumption.

The neck skin tracing system can e.g. comprise a conveying band configured to transport the neck skin simultaneously and optionally side-to-side with the poultry carcass. The neck skin tracing system can e.g. comprise a neck skin container for each neck skin, wherein the neck skin container is traceable, e.g. via a barcode or QR-code.

In embodiments, the pre-evisceration device further comprises an overhead conveyor comprising a plurality of shackles, wherein each shackle is configured to hold a poultry carcass suspended by the legs with the neck hanging downwards and move the poultry carcass in a transport direction. The overhead conveyor may be embodied according to any of the variants the skilled person knows. The overhead conveyor may e.g. move the poultry carcass through the pre-evisceration device. The overhead conveyor may be configured to keep moving the poultry carcass while the pre-evisceration device removes the neck skin, e.g. when the pre-evisceration device is part of a carousel machine. The overhead conveyor may be configured to keep the poultry carcass stationary while the pre-evisceration device removes the neck skin.

The invention further relates to an evisceration system comprising a pre-evisceration device according to any of the preceding embodiments described herein, and an evisceration device comprising an evisceration tool for eviscerating the viscera pack, including the crop and esophagus, from a vent end of the poultry carcass after the neck skin has been removed from the poultry carcass by the pre-evisceration device. The pre-evisceration device and evisceration device may be arranged at a single processing station or distributed over two (e.g. subsequent) processing stations. The evisceration device may be embodied according to any of the variants the skilled person knows, e.g. applying one or more of the features and/or steps as EP3171699, EP2779836, or EP1764001, which are incorporated herein by reference. The evisceration tool may e.g. be an evisceration spoon.

The invention further relates to a poultry processing system comprising multiple pre-evisceration devices or evisceration systems according to any of the embodiments described herein, integrated in a carrousel machine; and/or comprising multiple skin grabbers integrated in a carrousel machine and a single skin slitter arranged at a circumference of the carrousel machine. A carrousel machine may advantageously allow accurate processing while maintaining high speed in the processing line. For example, multiple skin grabbers may be configured to move in a circular trajectory in a carrousel machine while grabbing the neck skin of a poultry carcass. Optionally, a single skin slitter can be provided for the plurality of neck deskinners, arranged (optionally stationary) at the circumference of the carrousel machine.

The invention further relates to one or more methods. Although the methods can be performed with the devices according to the invention; neither the devices, nor the methods are limited thereto. Features explained herein with reference to the devices have the same meaning with respect to the methods unless explicitly defined otherwise. Features explained with reference to the devices can be applied mutatis mutandis to the methods to achieve the similar advantages.

The object of the invention can e.g. be achieved with a method for preparing the evisceration of a poultry carcass, comprising a step of removing at least a part of the neck skin from the poultry carcass by using the pre-evisceration device or evisceration system according to any of the embodiments described herein.

The object of the invention can e.g. be achieved with a method for preparing the evisceration of a poultry carcass, wherein the poultry carcass is optionally beheaded and comprises:
at least a part of the neck and the neck skin,
a viscera pack comprising at least the esophagus and the crop,
   wherein the method comprises a step of removing the neck skin from the poultry carcass prior to the evisceration of the viscera pack, wherein optionally use is made of the pre-evisceration device or evisceration system according to any of the embodiments described herein.

Exemplary embodiments of the invention are described using the figures. It is to be understood that these figures merely serve as example of how the invention can be implemented, and are in no way intended to be construed as limiting for the scope of the invention and the claims. Like features are indicated by like reference numerals along the figures. In the figures:

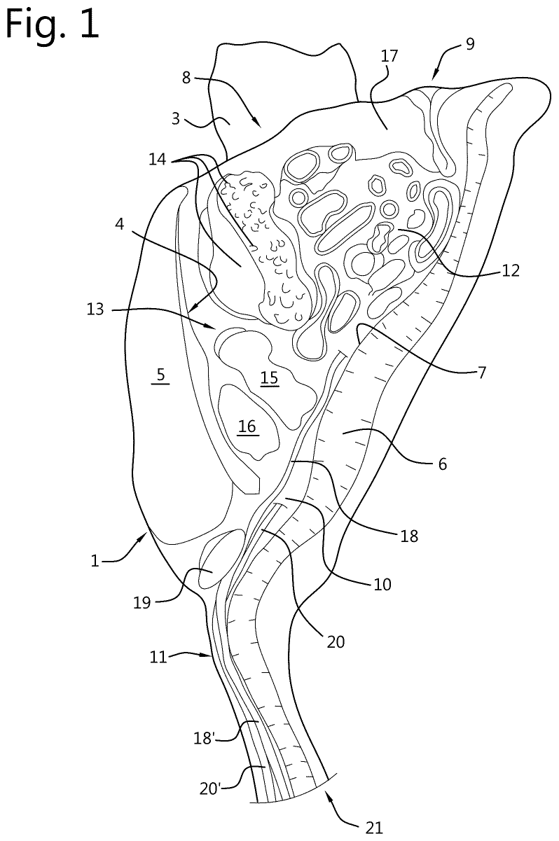

FIG. 1: shows a cross-section of a poultry carcass;

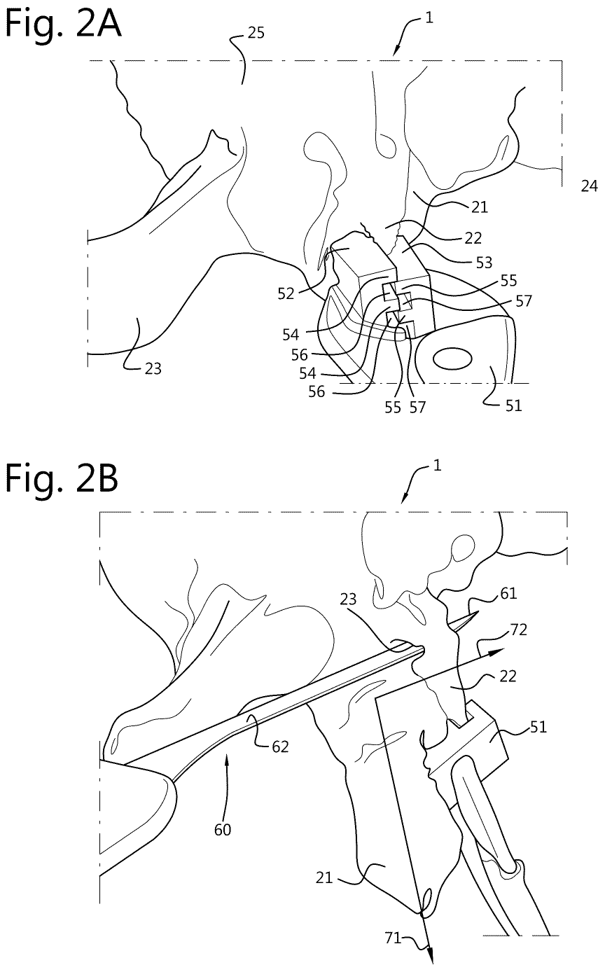

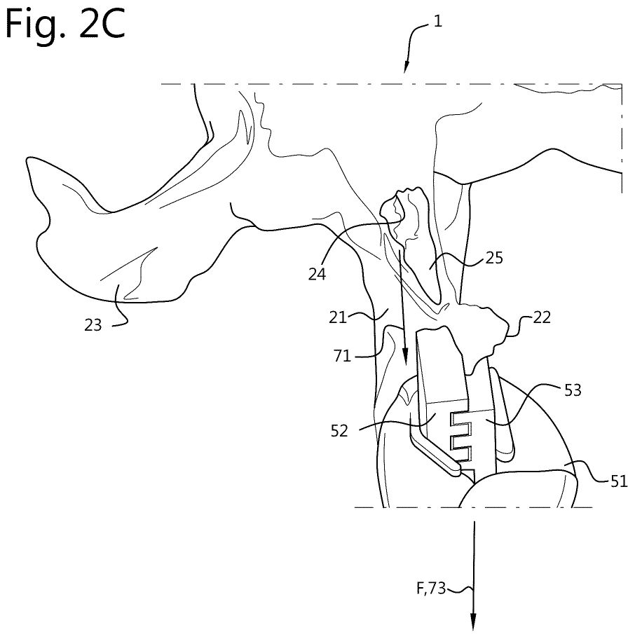

FIG. 2A-2C: schematically illustrate a working principle of an embodiment of the invention;

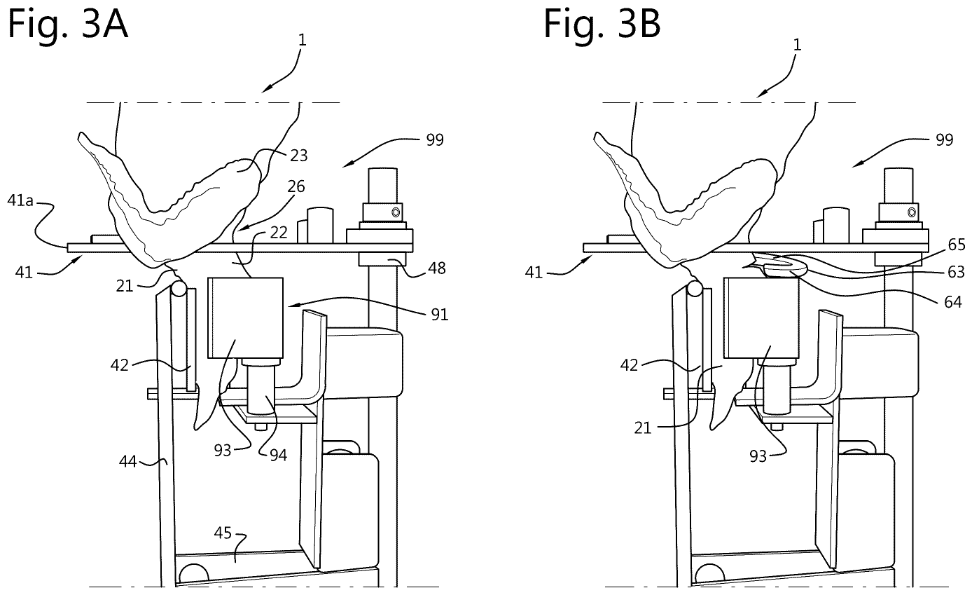

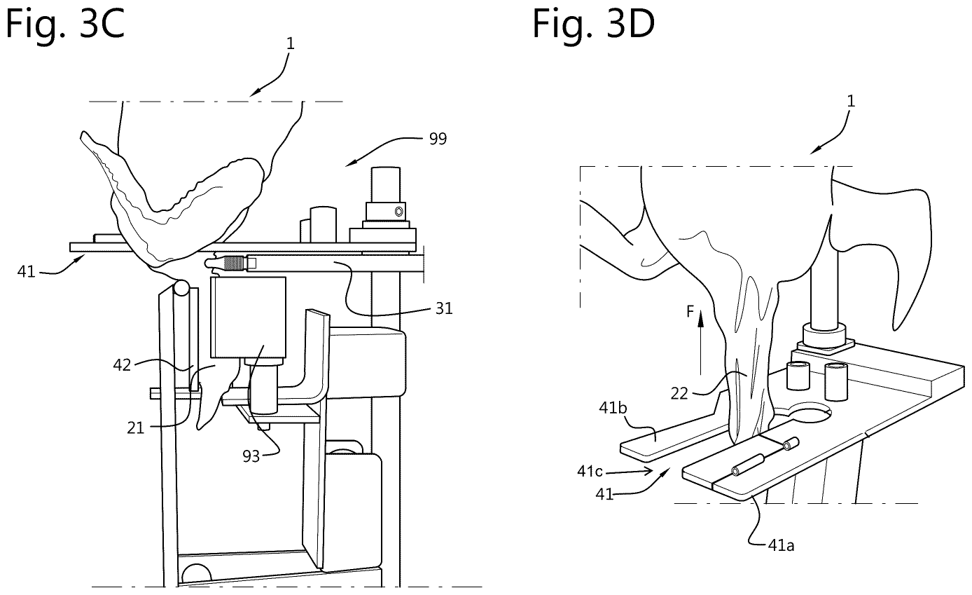

FIG. 3A-3D: schematically illustrate a first embodiment of a pre-evisceration device;

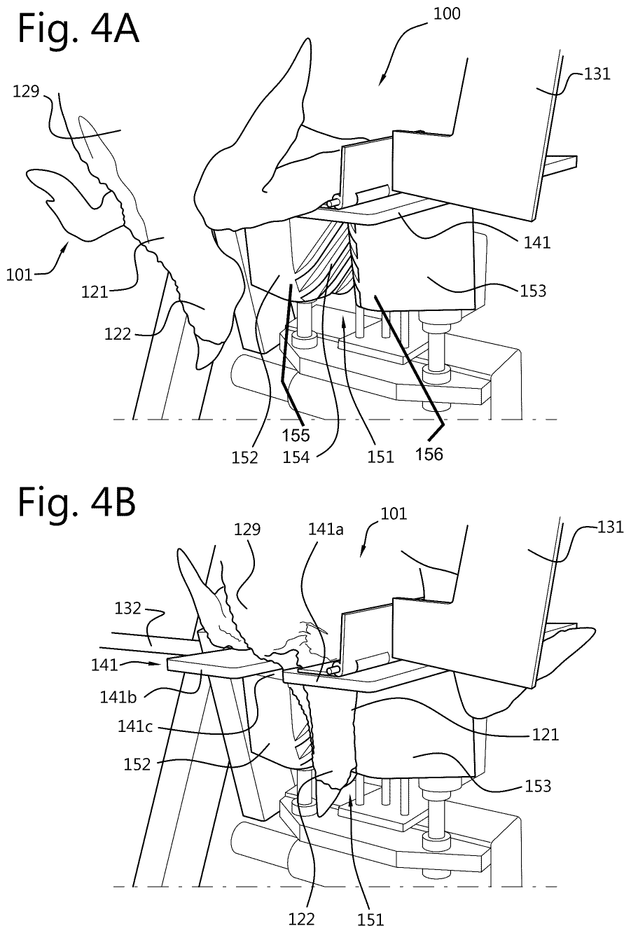

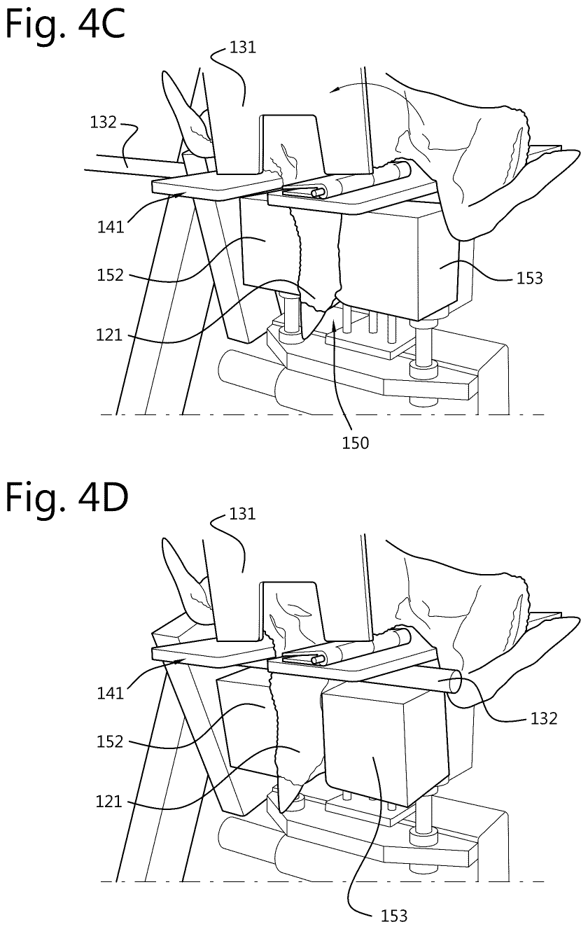

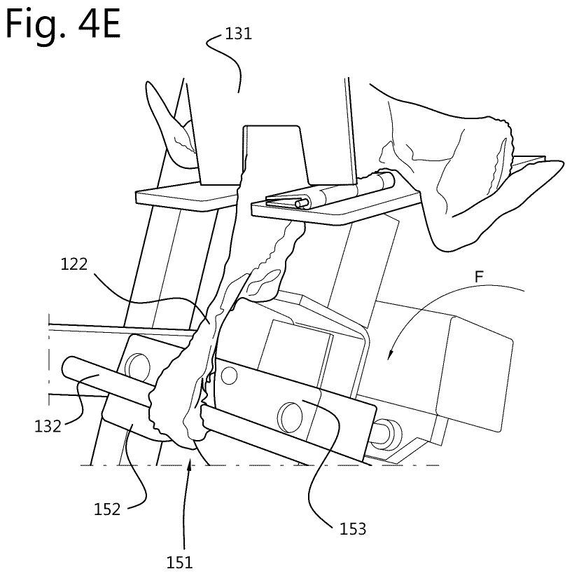

FIG. 4A-4E schematically illustrate a second embodiment of a pre-evisceration device;

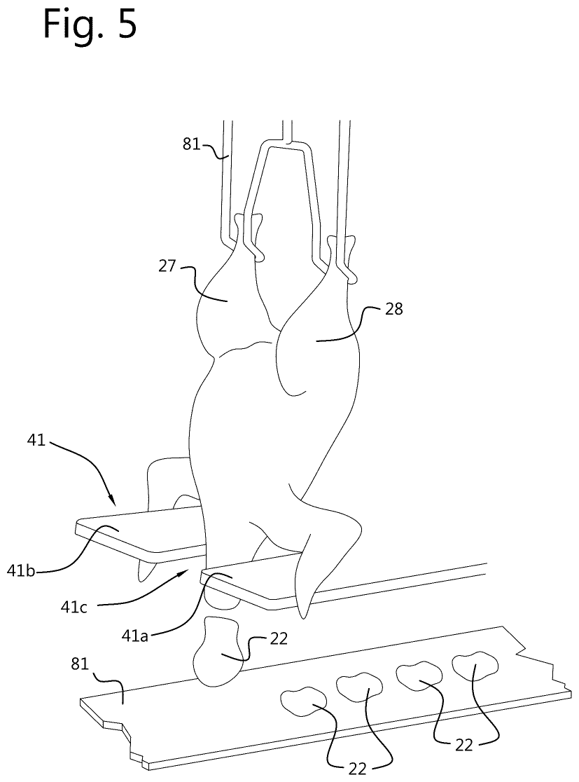

FIG. 5: schematically illustrates a skin collector with a neck skin tracing system.

In order to facilitate the understanding of the present invention, FIG. 1 shows a cross-section of a poultry carcass 1, in this case a chicken carcass 1, in neck down orientation. This is usually the orientation in which the poultry carcass 1 is transported by an overhead conveyor, e.g. while being suspended by the legs in a shackle. FIG. 1 shows the carcass and the location within the body cavity thereof of the organs as discussed herein. FIG. 1 has been obtained by deep-freezing a slaughtered chicken whilst suspended from its legs and cutting the frozen chicken in half, thereby opening the body cavity.

In FIG. 1 the following parts of the poultry carcass 1 are provided with reference numerals: leg 3, breast side 4 of the body cavity, breast fillet meat 5, vertebra 6, back side 7 of body cavity, vent end 8 of body cavity, vent or cloaca 9, neck end 10 of body cavity, neck 1 1, neck opening 21, intestines 12, gizzard 14, liver 15, heart 16, belly fat 17, esophagus 18, with part 18′ at neck side of the crop, crop 19, trachea 20, with part 20′ at neck side of the crop. In this example, the poultry carcass 1 has previously been beheaded and befeathered, such that no head or feathers are visible. The neck opening 21 shows the location where the head has been removed. In other embodiments, however, it is possible that the poultry carcass 1 still comprises the head.

The gizzard 14 is depicted here with food remnants, e.g. of seeds, still present in the gizzard. The crop 19 is depicted slightly expanded. The crop 19 functions to temporarily store food. Generally, poultry that is about to be slaughtered is kept void of food for some time, with the goal that the crop 19 of slaughtered poultry 1 is empty by the time the poultry is slaughtered. In practice, however, remnants of food or other consumed objects may still be present in the crop 19 at times.

The entirety of the organs is identified as viscera pack with reference numeral 13. Most of the viscera pack 13 is located in the body cavity of the carcass 1. The viscera pack 13 includes, among others, the crop 19, the esophagus 18 and trachea 20. Traditionally, the viscera pack 13 is removed from the poultry carcass 1 as one of the first steps after the beheading, before any further skin or meat is harvested. A vent opening can be made around the vent 9, through which an evisceration tool can be inserted into the body cavity. The evisceration tool can e.g. comprise a spoon, hook, or similar, which is used to grab the lowest (in the orientation shown in FIG. 1) organs it can reach. The viscera pack 13 is then pulled out of the body cavity via the vent opening.

Not all organs of the viscera pack 13 are completely loosened from the poultry carcass 1 prior to evisceration, as this would be too complicated and time consuming. Therefore, several tissue connections between the organs and the poultry carcass 1 must be broken by a pulling force exerted by the evisceration tool when pulling the viscera pack out of the body cavity. FIG. 1 illustrates that the esophagus 18 and trachea 20 are extending from the neck opening 21 towards the body cavity, and that for the rest of the organs the crop 19 is the closest to the neck opening 21. The esophagus 18 and trachea 20 have respective parts 18′ and 20′ that are connected to the neck 11. Relatively large pulling forces are required to break the connection between the parts 18′, 20′ and the neck 11. The crop 19, on the other hand, is a relatively weak organ. As a result of the pulling force, it happens frequently that the crop 19 breaks before the parts 18′, 20′ are loosened from the neck 11. This may result in contamination from the contents in the crop 19 which need to be cleaned in a subsequent step. Even if the crop 19 was completely empty, an additional step is required to remove the remnants of the esophagus 18 and trachea 20 (and sometimes the crop 19) which were not removed during the evisceration.

The invention proposes a pre-evisceration device, of which the working principle according to possible embodiments is schematically illustrated in FIGS. 2A-2C. FIG. 2A illustrates a poultry carcass 1 that has not been eviscerated yet. Also in this example, the poultry carcass 1 is beheaded and befeathered, but still has the neck 21 (note that in the view FIG. 2A a part of the neck is blocked by skin grabber 51) and—since it is a pre-evisceration device-the viscera pack (not visible in FIG. 2A) which comprises at least the esophagus and crop (usually also the trachea and other organs of the viscera pack). FIG. 2A also shows the wings 23, 24, and the back 25 of the poultry carcass 1.

The pre-evisceration device comprises a skin grabber 51 which is configured to grab the neck skin 22, as shown in FIG. 2A. In this example, the neck skin 22 is grabbed at a back-side of the neck 21. In addition, the neck skin 22 is grabbed at the back-end of the neck 21, which in this case corresponds with higher arranged end, since the poultry carcass 1 is suspended upside-down.

The skin grabber 51 comprises a first jaw part 52 and a second jaw part 53, which are moved towards each other to grab the neck skin 22. The pre-evisceration device may comprise a driving mechanism (not shown) for moving the first 52 and second jaw part 53 towards each other.

In the shown example, both the first 52 and the second jaw part 53 have a toothed profile with protrusions 54, 55 and recesses 56, 57. The protrusions 54 of the first jaw part 52 are arranged into the recesses 57 of the second jaw part 53 and vice versa, when the jaw parts 52, 53 are moved towards each other. This improves the grabbing of the neck skin.

FIG. 2B illustrates that the pre-evisceration device further comprises a skin slitter 60. The skin slitter makes a slit 23 in the neck skin 22. In this example, the slit 23 is made after the skin grabber 51 has grabbed the neck skin 22. This may be advantageous as the neck skin 22 is held tighter by the skin grabber 51 which may make it easier for the skin slitter 60 to make the slit 23. However, this is not required and can also be performed in the opposite order, i.e. the slit 23 can be made before the skin grabber 53 grabs the neck skin 22.

In the shown example the skin slitter 60 is stationary while the poultry carcass 1 is being moved. In FIG. 2B, the poultry carcass 1 is being moved at least partially towards the left-hand side. In other embodiments it is possible that the skin slitter 60 is being moved while the poultry carcass 1 is stationary, or that both the skin slitter 60 and the poultry carcass 1 are being moved. The skin slitter 60 is embodied as a blade that comprises a tip 61 which is sharp, and is introduced into the neck skin 22 being held by the skin grabber 51. This makes a first incision opening in the neck skin 22. The skin slitter further comprises a sharp edge 62 which completes the slit 23.

A longitudinal direction 71 of the neck 21 is schematically illustrated in in FIG. 2B. It can be seen that the slit 23 is made in a direction 72 substantially perpendicular to said longitudinal direction 71. That is, when the slit 23 has been made, it extends in the direction 72. This is advantageous because in subsequent steps, it is better defined and more predictable how the neck skin 22 is removed from the neck 21. FIG. 2B illustrates that an angle between the longitudinal direction 71 and the direction 72 of the slit 23 may deviate slightly from 90 degrees, e.g. up to 5, 10, or 15 degrees more or less than 90 degrees.

FIG. 2C illustrates that after the slit has been made, a pulling force F can be exerted on the neck skin 22. In this case the skin grabber 51 exerts said pulling force F by moving the first jaw part 52 and the second jaw part 53 simultaneously. The movement of the first 52 and second jaw part 53 and consequently the pulling force F are in a direction 73 substantially perpendicular to the direction in which the slit was made. The direction 73 is substantially downwards when the poultry carcass 1 is suspended by the feet, and thereby parallel with the longitudinal direction of the poultry carcass 1.

FIG. 2C illustrates that a gap 25 is formed while the neck skin 22 is being pulled downwards. The upper (in the view shown in FIG. 2C) border 24 of the gap 25 is defined by the slit that was previously made. This illustrates one of the advantages of the direction of the slit and the direction of the pulling force F. It will be understood that as the skin grabber 51 moves further downward, the slit increases in circumferential direction and the gap 25 increases in both circumferential and longitudinal direction. Eventually the neck skin 22 is torn off the neck 21.

The inventors have found that when the neck skin 22 is removed from the neck 21, the connections between the esophagus and the neck 21, as well as between the trachea and the neck 21, become weaker. When said connection are weaker than the crop, they become the breaking point during the evisceration. This results in less crop breakage and more efficient removal of the esophagus and trachea during evisceration.

FIG. 3A-3D schematically illustrates a first embodiment of the pre-evisceration device 99 using a neck positioner comprising a shoulder support 41 and a neck support. The shoulder support 41 is arranged below a shoulder region 26 of the poultry carcass 1, which in this example has been previously beheaded and defeathered. Although not all visible in the side view of FIG. 3A (similar shoulder supports are better visible in FIGS. 4A-4e, 5), the shoulder support 41 two shoulder support extensions 41a that each support a shoulder. A recess is arranged between the shoulder support extensions, through which the neck 21 of the poultry carcass can be arranged. Supporting the poultry carcass 1 by the shoulder region 26 has the advantage that variations in poultry size have limited effect. With the position of the shoulder being predetermined, only variations in the neck size affect the location where the slit is made and where the neck skin is grabbed. However, since the neck 21 is relatively small compared to the rest of the poultry carcass 1, the effect of these variations is small and will have limited impact on the working of the pre-evisceration device.

FIG. 3A-3C further illustrate a skin grabber 91, which comprises two skin grabbing blocks, which function as first and second jaw parts. Only a second skin grabbing block 93 is visible in the side views of FIG. 3A-3C. When the neck 21 is arranged into the recess of the shoulder support 41, the skin grabbing blocks 93 are in an open position. After positioning the neck 21, the skin grabbing blocks are pivoted towards each other to grab the neck skin 22, which has happened prior to the situation shown in FIG. 3A. The pivoting can be achieved by pivoting a pivoting member 94 per skin grabbing block 93. The pivoting members 94 are part of a driving mechanism. The skin grabbing blocks 93 may comprise a profile to enhance the grabbing of the neck skin 22. A similar skin grabber 151 is explained in more detail with reference to FIGS. 4A-4e further below.

FIG. 3A illustrates that the neck positioner in this example comprises a neck support 42. The neck support 42 is connected to a connecting element 44. When the poultry carcass 1 is being positioned into the shoulder support 41, the connecting element 44 was pivoted downwards to ensure that the neck support 42 does not obstruct the neck 21. When the neck 21 is in the recess of the shoulder support 41, the connecting element 44 can be pivoted upwards such that the neck positioner 42 engages the neck 21 for further positioning and supporting the neck 21.

FIG. 3A further illustrates that the various (shoulder and neck) supports 41, 42 are connected via various connecting elements 44, 45, 48 towards what in FIG. 3A is the right-hand side. In practice, the components shown in FIG. 3A may be arranged at the circumference of a carrousel device, wherein in FIG. 3A the centre of the carrousel device is arranged at the right-hand side.

The poultry carcass 1 may approach the carrousel device while being suspended by its legs in a shackle (not shown), the shackle being part of an overhead conveyor system comprising a plurality of shackles. The components in the carousel machine are rotating along the circumference of the carrousel machine. The movements of the shackle and the carrousel machine are synchronized in such a way that the poultry carcass 1 is positioned in the shoulder support 41. Optionally, additional guiding mechanism such as converging guiding bars or plates can be used for positioning the poultry carcass 1 in the shoulder support. Such features are commonly known to the skilled person and are therefore not shown in more detail.

Then the neck support 42 may be moved in position against the neck 21. This can e.g. be achieved because the neck support 42 is connected (via-among others-connecting elements 44, 45) to one or more follower wheels which follow a cam track in the drum of the carrousel. Changes (e.g. in vertical direction) in the cam track cause the movement of the neck support 42. Such features are also commonly known to the skilled person and are therefore not shown in more detail.

Then the skin grabber 91 may be activated for grabbing the neck skin. The pivoting members 94 can also be connected to a follower wheel following a cam track, thereby functioning as part of the driving mechanism for these components.

FIG. 3B illustrates that then a skin slitter 63 is activated. The skin slitter 63 in this embodiment comprises a first blade 63 and a second blade 64, that are configured to make a snipping movement for making a slit in the neck skin 22. It can be seen that this slit will extend in a direction perpendicular to the longitudinal direction of the neck 21. In the shown arrangement, the slit will extend in horizontal direction. The skin slitter 63 can also be connected to one or more follower wheels each following a cam track. These components cause the skin slitter 63 to move towards the neck 21 and make the snipping movement, and thereby function as part of the driving mechanism for the skin slitter 63. These components are not visible in FIG. 3B because the view is blocked by other components such as the skin grabbing block 93.

FIG. 3C illustrates that then a loosening unit is activated. In this example the loosening unit comprises two loosening members 31, of which only one is visible in FIG. 3C as the second is arranged behind the first loosening member 31. The loosening members 31 are moved into the slit made by the skin slitter 63. In this case, the loosening members are arranged on respective opposite sides of the esophagus. The loosening members 31 have a rounded tip and circular cross-section. Thus, they are not sharp and do not comprise a knife or blade.

The loosening members 31 can also be connected to one or more follower wheel each following a cam track. These components cause the loosening members 31 to move towards the neck 21 and thereby function as part of the driving mechanism for the loosening members 31. In the shown example the loosening members 31 are moved horizontally towards the neck 21 and into the slit.

FIG. 3D illustrates that then a pulling force F is exerted onto the neck skin 22. In this example, this is achieved by moving the poultry carcass 1 upwards, which can e.g. be achieved by the conveyor. While the carcass is moved upwards, the neck skin 22 remains clamped by the skin grabber, which causes slit to become a larger gap until the neck skin 22 is removed from the poultry carcass 1.

The loosening member remains in the position shown in FIG. 3C while the neck is moved upwards together with the poultry carcass 1. The relative movement of the neck to the loosening members causes the tissue around the esophagus to be loosened.

FIG. 3D illustrates in more detail shoulder support 41 with shoulder support extensions 41a, 41b and recess 41c.

After the neck skin has been removed and the tissue around the esophagus and trachea have been loosened, the poultry carcass 1 leaves the carrousel device and is further conveyed to an evisceration device, which may optionally also be embodied in a carrousel device.

A pre-evisceration device 100 according to another embodiment and the working principle is illustrated in FIGS. 4A-4E. FIGS. 4A and 4B illustrate that first a poultry carcass 101 is arranged in a shoulder support 141. The shoulder the shoulder support 141 two shoulder support extensions 141a, 141b that each support a shoulder. A recess 141c is arranged between the shoulder support extensions 141a, 141b, through which the neck 121 of the poultry carcass can be arranged. In this embodiment the shoulder support 141 forms the neck positioner.

In this embodiment the skin grabber 151 also comprises a first skin grabber block 152 and a second skin grabber block 153, which are in an open position when the poultry carcass 101 is being arranged in the pre-evisceration device 1. In FIG. 4A it visible that the first skin grabber block 153 comprises a grooved profile 154 with grooves on the inside. It will be understood that the second skin grabber block 153 comprises a similar profile, wherein the grooves of the first skin grabber block 152 can be arranged in recesses of the second skin grabber block 153 when the skin grabbing blocks 152, 153 are arranged into a closed position. In the closed position, the first skin grabber block 152 and the second skin grabber block 153 are closed towards each other. The grooved profile 154 pulls the neck skin 122 further between the first 152 and second skin grabbing block 153.

When the neck 121 is positioned in the recess 141c, a part of the neck 121 is arranged between the skin grabbing blocks 152, 153. In FIG. 4C, the skin grabbing blocks 152, 153 are moved into a closed position. This is done by a pivoting movement of the skin grabbing blocks 152, 153 towards each other, such that their respective profiles mesh. During this movement, the neck skin 122 is grabbed between the profiles of the skin grabbing blocks 152, 153. In the shown example, the neck skin 122 is grabbed on the back-side of the neck 121.

In FIG. 4B it can further be seen that first skin grabbing block 152 has a first neck-facing surface 155 with a curvature and the second skin grabbing block 153 has a second neck-facing surface 156 with a curvature. In the closed position as shown in FIG. 4D, these neck-facing surfaces 155,156 engage the neck 121. The curvature is adapted to the curvature of an average poultry neck. This way it ensured that the neck 121 is not pulled between the first and second skin grabber 152, 153 together with the neck skin 122.

Optionally a breast support 131 is then moved from an open position (FIGS. 4A-4B) to a closed position (FIG. 4C). The breast support 131 supports the breast of the poultry carcass 101, e.g. when the cut is made. The breast support 131 may be arranged in the closed position before or after the neck skin is grabbed by the skin grabber 151, but in the shown embodiment the breast support 131 must be in the open position to allow the poultry carcass 101 being positioned in the shoulder support 141. In this embodiment the breast support 131 has the shape of an inverted “U” (in the position in FIG. 4C), which allows to support the breast support 131 on the shoulder support 141 while at the same time supporting the breast 129 but not the neck 121. However, other embodiments are possible.

Then, the slit can be made in the neck 121 by a skin slitter. This is not visible in FIGS. 4A-4E, since the skin slitter is arranged behind the neck 121 and makes the slit in the back-side of the neck 121. The skin slitter in this case comprises a blade that is moved through the neck skin 122 slightly above the skin grabber 150 in a part of the neck skin 122 that is being held tight by the skin grabber 150. The skin slitter is moved in a horizontal direction such that the slit extends in horizontal direction, i.e. perpendicular to a longitudinal axis of the neck 121.

FIG. 4D illustrates that pin 132 can then be moved from a receiving position (FIGS. 4A-4C) to an operational position (FIG. 4D). The pin 132 extends in a direction perpendicular to the longitudinal direction of the neck 121, and is further embodied as a rod. In the operational position the pin 132 is arranged approximately where the slit is made, in this case being at the back-side of the neck 121 above the skin grabbing blocks 152, 153.

FIG. 4E illustrates that then the skin grabber 151 can exert a pulling force F on the neck skin 122. This is done by moving the skin grabbing blocks 152, 153 simultaneously while the neck skin 122 is still being grabbed. The neck skin 121 is being stretched and will eventually be torn off. The location where the neck skin 121 is torn off is well-defined by the slit.

In FIG. 4E said movement of the skin grabber 151 is a combination of forward rotation and a sloped downward movement, while the poultry carcass 101 is being held stationary. Other movements are possible however; for example, the skin grabber 151 can be moved in horizontal or vertical direction, and/or be rotated backwards. It is also possible that poultry carcass 101 is being moved, e.g. in opposite direction of the skin grabber 151 or while the skin grabber 151 is held stationary.

FIG. 4E further illustrates that the pin 132 is moved simultaneously with the skin grabber 151. During this movement, the pin 132 will enhance the pulling force exerted onto the neck skin 122.

Although not explicitly shown in FIGS. 4A-4E, the skilled person will understand that in this embodiment the pre-evisceration device can also be arranged at the circumference of a carousel machine. Any movement of the components as explained can be achieved using follower wheels being activated by cam tracks on the carousel drum, wherein said follower wheels are connected to the moving components, optionally via intermediate connections. Alternatively, it is possible to provide the pre-evisceration device in a linear arrangement in the processing line, wherein e.g. the movement of components can be achieved using actuators.

FIG. 5 schematically illustrates a skin collector 81 which provides a neck skin tracking system. The poultry carcass 1 can be seen being suspended by its legs 27, 28 in the shackle 81 of the overhead conveyor system. The shoulder support 41 with shoulder support extensions 41a, 41b and recess 41c are visible. The neck skin 22 of the poultry carcass 1 has just been removed and is falling down after being released by the skin grabber. Components such as the skin grabber, neck positioner, and loosening unit are omitted from FIG. 5 to enhance the clarity.

Below the poultry carcass 1 the skin collector 81 is provided. In this example, the skin collector 81 is embodied as a conveyor belt 81 onto which the neck skin 22 falls. The movement of the conveyor belt 81 and the (shackles 81 of the) overhead conveyor system are coordinated with each other, in such a way that the neck skin 22 arrives at an inspection station in a way that it can be matched to the poultry carcass 1 from which it was removed. The inspection station is usually downstream of the evisceration device, which in turn is downstream of the pre-evisceration device. It is usually the viscera pack that is being inspected after the evisceration, as the organs may reveal a disease or other problem. Consequently, the inspection may occur after the neck skin is removed, meaning that it is not possible to know at the moment of harvesting the neck skin 21 whether the poultry carcass 1 will pass the inspection. The inspection may be visual by an operator or using a camera with applying an inspection algorithm. If for some reason the viscera pack is rejected in the inspection, the neck skin 22 removed from the same carcass part 1 can be identified, such that it can be prevented that this particular neck skin 21 is used for consumption. The other neck skins 21, on the other hand, can safely be used for consumption knowing the poultry they originate from was not rejected.

As required, detailed embodiments of the present invention are described herein; however, it is to be understood that the disclosed embodiments are merely examples of the invention, which may be embodied in various ways. Therefore, specific structural and functional details disclosed herein are not to be construed as limiting, but merely as a basis for the claims and as a representative basis for teaching those skilled in the art to practice the present invention in various ways in virtually any suitable detailed structure. Not all of the objectives described need be achieved with particular embodiments.

Furthermore, the terms and expressions used herein are not intended to limit the invention, but to provide an understandable description of the invention. The words “a”, “an”, or “one” used herein mean one or more than one, unless otherwise indicated. The terms “a multiple of”, “a plurality” or “several” mean two or more than two. The words “comprise”, “include”, “contain” and “have” have an open meaning and do not exclude the presence of additional elements. Reference numerals in the claims should not be construed as limiting the invention.

The mere fact that certain technical features are described in different dependent claims still allows the possibility that a combination of these technical measures can be used advantageously.

A single processor or other unit can perform the functions of various components mentioned in the description and claims, e.g. of processing units or control units, or the functionality of a single processing unit or control unit described herein can in practice be distributed over multiple components, optionally physically separated of each other. Any communication between components can be wired or wireless by known methods.

The actions performed by the control unit can be implemented as a program, for example computer program, software application, or the like. The program can be executed using computer readable instructions. The program may include a subroutine, a function, a procedure, an object method, an object implementation, an executable application, a source code, an object code, a shared library/dynamic load library and/or other set of instructions designed for execution on a computer system.

A computer program or computer-readable instructions can be stored and/or distributed on a suitable medium, such as an optical storage medium or a solid-state medium supplied with or as part of other hardware, but can also be distributed in other forms, such as via internet or other wired or wireless telecommunication systems.

1. A pre-evisceration device for preparing the evisceration of a poultry carcass, wherein the poultry carcass is optionally beheaded, comprising:
at least a part of a neck and a neck skin,
a viscera pack comprising at least an esophagus and a crop,
wherein the pre-evisceration device comprises a neck deskinner configured to remove at least a part of the neck skin from the poultry carcass prior to evisceration of the viscera pack.

2. The pre-evisceration device according to claim 1, wherein the neck deskinner comprises:
a skin grabber configured to grab the neck skin;
a skin slitter configured to make a slit in the neck skin;
wherein the neck deskinner is configured to exert a pulling force on the neck skin after the slit has been made for removing the neck skin from the poultry carcass.

3. The pre-evisceration device according to claim 2, wherein the skin slitter is configured to make the slit in a direction substantially perpendicular to a longitudinal direction of the neck.

4. The pre-evisceration device according to claim 1, further comprising a loosening unit configured to loosen at least a part of the tissue surrounding the esophagus after the neck skin has been removed by the neck deskinner.

5. The pre-evisceration device according to claim 4, wherein the loosening unit is further configured to loosen at least a part of the tissue surrounding the trachea after the neck skin has been removed by the skin grabber.

6. The pre-evisceration device according to claim 5, wherein the loosening unit comprises at least one loosening member, optionally two loosening members, wherein the loosening member is configured to move in the longitudinal direction of the esophagus for loosening the tissue.

7. The pre-evisceration device according to claim 1, further comprising a neck positioner configured to arrange the neck of the poultry carcass in a predetermined position prior to the neck skin being removed.

8. The pre-evisceration device according to claim 7, wherein the skin grabber comprises a first jaw part and a second jaw part configured to close towards each other for grabbing the neck skin and wherein optionally the skin grabber is configured to move the first and second jaw part simultaneously for pulling the neck skin away from the neck.

9. The pre-evisceration device according to claim 7, wherein the skin grabber comprises a rotatable gripper roll and a counter member, wherein the skin grabber is configured to grab the neck skin between the rotatable gripper roll and the counter member, and to pull the neck skin away from the neck by rotating the rotatable gripper roll.

10. The pre-evisceration device according to claim 7, wherein the skin grabber comprises a first skin grabber block pivotable about a first pivot axis and a second skin grabbing block pivotable about a second pivot axis, wherein the first skin grabbing block and the second skin grabbing block are configured to be pivoted about the first pivot axis and the second pivot axis, respectively, between an open position for receiving the neck skin and a closed position for grabbing the neck skin, wherein:
the first skin grabbing block and the second skin grabbing block both comprise a grooved profile with a plurality of grooves and a plurality of recesses, wherein in the closed position the plurality of grooves of the first skin grabbing block are arranged in the plurality of recesses of the second skin grabbing block and vice versa, wherein optionally the plurality of grooves extend at an angle with both the horizontal and the vertical direction, and/or
the first skin grabbing block and the second skin grabbing block both comprise a neck-facing surface having a curvature, and are configured to face and engage the neck when the first skin grabbing block and the second skin grabbing block are arranged in the closed position.

11. The pre-evisceration device according to claim 10, wherein the skin slitter comprises a stationary blade.

12. The pre-evisceration device according to claim 10, further comprising: a skin collector configured to receive the neck skin after being removed from the neck, and a neck skin tracing system configured to enable identifying from which poultry carcass the neck skin has been removed.

13. An evisceration system comprising a pre-evisceration device according to claim 10, and an evisceration device comprising an evisceration tool for eviscerating the viscera pack, including the crop and esophagus, from a vent end of the poultry carcass after the neck skin has been removed from the poultry carcass by the pre-evisceration device.

14. A poultry processing system comprising:
multiple pre-evisceration devices or evisceration devices according to claim 13 integrated in a carrousel machine; and/or
multiple skin grabbers integrated in a carrousel machine and a single skin slitter arranged at a circumference of the carrousel machine.

15. A method for preparing the evisceration of a poultry carcass, wherein the poultry carcass is optionally beheaded and comprises at least a part of the neck and the neck skin, and a viscera pack comprising at least the esophagus and the crop, the method comprising:
removing the neck skin from the poultry carcass prior to the evisceration of the viscera pack, wherein optionally use is made of the pre-evisceration device or evisceration system according to claim 12.
